(19) United States
(12) Patent Application Publication
(10) Pub. No.: US 2007/0160720 A1
(43) Pub. Date: Jul. 12, 2007

(54) METHOD AND APPARATUS FOR TREATING FOOD PRODUCTS

(75) Inventor: Christian Grosse-Butenuth, Steinhagen (DE)

Correspondence Address: RICHARD M. GOLDBERG, 25 EAST SALEM STREET, SUITE 419, HACKENSACK, NJ, 07601, US

(73) Assignee: SCHRODER MASCHINENBAU KG, Werther (DE)

(21) Appl. No.: 11/618,976

(22) Filed: Jan. 2, 2007

(30) Foreign Application Priority Data
Jan. 11, 2006 (DE) 10 2006 001 341.7

(51) Int. Cl. A23L 3/26

(52) U.S. Cl. 426/240

(57) ABSTRACT

A method for treating food products (12), in which the mass of the food products to be treated is measured, and an amount of liquid, adjusted to the measured mass, is injected into the food products, and the mass of the food products (12) is determined radiometrically.

The invention relates to a method of treating food products, wherein the mass of the food products to be treated is measured, and an amount of a liquid, adjusted to the measured mass, is injected into the food products, as well as an apparatus for carrying out such a method. In particular, the invention relates to a method and an apparatus for pickling meat products.

DE 34 20 019 C2 discloses a method of this type, wherein the meat products are weighed on a mechanical weighing machine prior to and after the injection of brine, so that the increase in mass achieved by the injection of the brine can be determined, and the injection process can then be adjusted such that each of the meat products obtains the correct amount of brine in relation to its mass.

DE 692 13 487 T2 discloses an injection method, wherein the food products are weighed before and after the injection by means of mechanical passage-type weighing machines.

However, by mechanically weighing the food products, only a limited accuracy can be achieved. It is another disadvantage that the weighing machines with bear weighing tables are cumbersome to be integrated into a production line wherein the food products are continuously conveyed through various processing and measuring stages. In particular, when the food products are placed onto the weighing table, oscillations of the latter are induced, which further compromise the accuracy of the measurement and/or lengthen the measuring time.

It is therefore an object of the invention to provide a method for treating food products which permits a more accurate and efficient metering of the injected amount of liquid dependent on the mass of the food products.

This object is achieved by a method of the type indicated above, wherein the mass of the food products is determined radiometrically.

In the radiometric measuring process, which is known as such, the objects to be measured, in this case the food products, are irradiated with radioactive radiation, e.g. gamma radiation, and the mass of the products is derived from the measured absorption of radiation by reference to the known absorptivity of the products for the pertinent radiation. It has turned out that this method permits to determine the mass of food products, especially the increase in mass occurring during the injection of the liquid, with surprisingly high accuracy. Moreover, the method is very robust against mechanical disturbances of any kind and is practically not influenced, neither, by the specific posture or bulk state of the products in the radiometric measuring stage. It is an advantage that the radiometric measuring stage can readily be integrated in a continuously operating processing line for the food products. The doses of radiation that are necessary for a sufficiently exact measurement and to which the food products are exposed during the measurement are not problematic in view of health and radiation safety.

The method is suitable for food products of any kind, in particular for pork, poultry, parts of poultry such as wings, legs and the like, and also for the injection of rennet or fungal seed solutions in cheese. The food products may also include bones, for example. The increase in mass caused by the injection of the liquid and hence the increase in absorption of radiation is independent of the contents of bones of the products. Moreover, the influence of the contents of bones, which is known relatively exactly for each type of product, onto the absorption of radiation can be corrected by calculations, if necessary, in order to determine the absolute mass of the products.

Another subject of the invention is an apparatus for carrying out the method.

Useful embodiments and further improvements are indicated in the dependent claims.

Preferably, a first radiometric mass measurement is performed prior to the injection of the liquid, and a second radiometric mass measurement is performed after the injection, so that the increase in mass caused by the injection of the liquid can be determined exactly. Then, the parameters of the injection process may, e.g. in a feedback-loop, be adjusted in accordance with the measured result, so that the injected amount of liquid corresponds exactly to the demand.

Preferably, a conveyer is used for conveying the food products through a radiometric measuring stage in which they pass through a radiation curtain that extends transverse to the direction of conveyance. The radiation that has passed through the food products (and the conveyer) is then detected with one or more sensors on a line extending transverse to the direction of conveyance, and the absorption can then be calculated from the difference between the known radiation power of the radiation source and the measured intensity as integrated along the measuring line. From the absorption obtained in this way, after subtracting the known absorption of the conveyer, the mass of the food products can be determined by reference to gage measurements that have been performed in advance for each type of product. More specifically, an individual measurement measures the mass of a disk-shaped segment of the food product or products that is present in the radiation curtain. By continued or periodically repeated measurements, the mass flow rate can then be determined with the desired time resolution.

By comparing the measured results obtained before and after the injection, the increase in mass and hence the amount of liquid that has been injected can be determined precisely. The measurement of the mass increment is largely independent of the type of the product, because the increase in absorption is essentially dependent only on the absorptivity of the injected liquid. Moreover, the radiometric measurement that is performed prior to the injection also provides an indication for the initial weight of the food products, so that it is also possible to determine the percentage of the relative mass increment occurring during the injection, and then to regulate the same as desired by suitably controlling the injection process.

In order to smoothen-out statistical fluctuations, it is convenient to integrate the measured results over a certain number of measurements. e.g. one to ten measurements during a time span of about 1-5 minutes, and then to use the average of the relative mass increments for adjusting the parameters of the injection process.

An embodiment example will now be described in conjunction with the drawing, wherein:

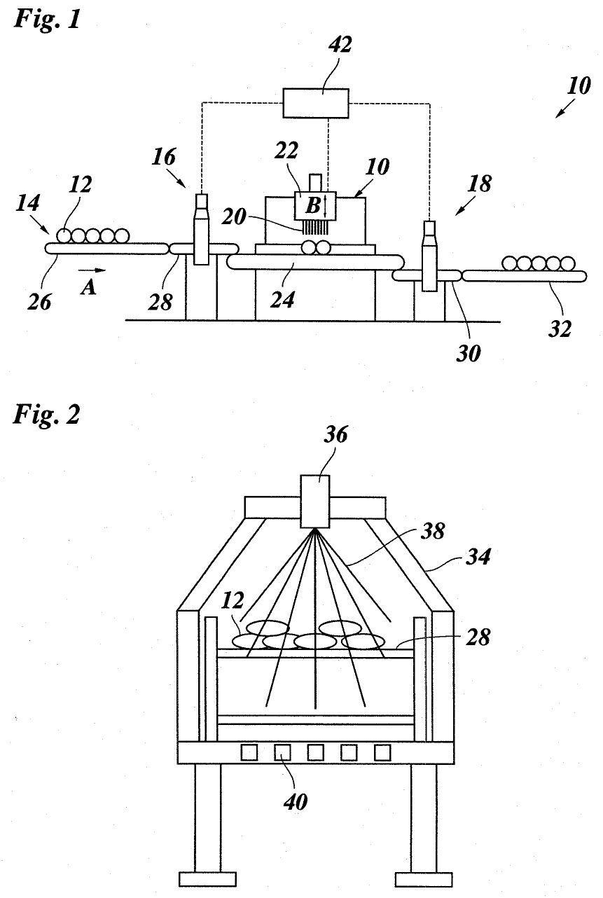

FIG. 1 is a sketch of a pickling device; and

FIG. 2 is a schematic cross-sectional view of a radiometric measuring stage.

The pickling device shown in FIG. 1 comprises an injector 10 for injecting brine into food products 12, a conveyer 14 conveying the food products 12 in the direction of an arrow A through the injector 10, and two radiometric measuring stages 16, 18, one of which (16) is arranged at the conveyer 14 in front of the injector 10 and the other (18) of which is arranged at the conveyer 14 behind the injector, as seen in the direction of conveyance.

The injector 10, the general construction of which is known for example from DE 98 27 685 C2, comprises a needle carrier 22 which is equipped with hollow needles 20 and is arranged above a conveyer belt 24 forming part of the conveyer 14 and is movable up and down in the vertical direction of a double-headed arrow B. The food products 12 are cyclically supplied on the conveyer belt 14, and when the conveyer belt stops, the needle carrier 22 is lowered, so that the hollow needles 20 penetrate into the food products. Brine is then injected into the food products through the hollow needles. For a given pressure and flow rate of the brine, the amount of brine injected into the food products is given by the dwell time of the needles in the product. The injection pressure is of the order of 0.1 to 0.45 MPa (1.45 bar), for example. When the needle carrier 22 has been lifted again, the next cycle of the conveyer belt 24 starts, so that new products are supplied to the injector.

On the upstream side, on the left side in FIG. 1, the conveyer 14 comprises a continuously driven conveyer belt 26 on which the food products 12 are supplied to the measuring stage 16. The measuring stage 16 includes another continuously driven conveyer belt 28 which then carries the food products within the measuring stage through a radiation curtain. Then, the products are transferred onto the conveyer belt 24 that advances cyclically.

Downstream of the injector 10, the food products, into each of which has been injected a certain amount of brine, are transferred from the conveyer belt 24 onto a continuously driven conveyer belt 30 of the measuring stage 18, and after the products have again passed through a radiation curtain in the measuring stage 18, they are discharged continuously via a conveyer belt 32.

In FIG. 2, one of the measuring stages, e.g., the stage 16, has been shown in a schematic cross-sectional view. The conveyer belt 28 is surrounded on all sides by a casing 34 which forms a radiation-proof shield and which has a radiation source 36 arranged in a top wall thereof above the conveyer belt 28. This radiation source emits gamma radiation in the form of a radiation curtain 38 that extends transversely over the conveyer belt 28 onto the food products 12. The radiation passes also through the upper and lower lumps of the conveyer belt 28. In the lower wall of the casing 34, a plurality of sensors 40 are arranged on a line extending transversely of the conveyer belt 28 for detecting an absorption profile of the gamma radiation which has passed through the food products 12 and the conveyer belt. This absorption profile is integrated over the width of the conveyer belt, so that, after subtracting the known absorption of the conveyer belt 28, one obtains an indication for the mass of the segment of the food products 12 that is momentarily present in the radiation curtain 38.

In the direction normal to the plane of the drawing, the casing 34 is open at least at those locations where the conveyer belt 28 and the food products enter and exit. In this direction, however, the gamma radiation emitted from the radiation source 26 is focused so sharply that no radiation that would be hazardous for health will escape. In a modified embodiment, an open frame may be provided instead of the closed casing. Then, protective shields or other blocking means are preferably so arranged at the frame that the operating personnel is prevented from gripping with the hand into the zone that is contaminated by radiation.

The construction and the function of the measuring stage 18 is identical to that of the measuring stage 16 described above. In particular, the radiation curtain 38 has the same profile, so that the mass detection before and behind the injector 10 is always performed for segments of the food products 12 of equal thickness, and, accordingly, the measured results can be compared directly.

The results obtained from the measuring stages 16 and 18 are supplied to an electronic control unit 42. There, the mass throughput with which the products are supplied to the injector 10 is calculated on the basis of the data from the measuring stage 16 and the known absorptive properties of the food products 12, possibly with a bone content being taken into account. Further, by comparing the results from the measuring stages 16 and 18, the mass increment is calculated that has been caused by the injection of brine. These quantities are then used for calculating the relative mass increment relative to the mass of the food products, and the increment is integrated over several measuring cycles distributed over a time span of 1-5 minutes. The operating parameters of the injector 10, in particular the amount of brine determined by the dwell time of the needles in the product, is adjusted by the control unit 42 so that the relative mass increment is feedback-controlled to a target value with an accuracy of, for example, ±1% or less.

The target values for the relative mass increment may be set within a range from 7 to 80%.

The method described above permits to pickle the food products 10 with a very precisely metered amount of brine, and at the same time permits a remarkably high processing speed. For example, the conveyer belt 24 of the injector 10 may operate with a cycle frequency of 15-60 cycles per minute, and the average conveyer speed of the conveyer 14 may be in the range from 1.5 to 9.0 m/min. For a width of the conveyer belts 24-32 from 400 to 600 mm, a processing capacity of up to 10000 kg per hour can thus be obtained, depending upon the type of product.

1. A method for treating food products, comprising the steps of:
radiometrically measuring the mass of the food products to be treated, and
injecting an amount of liquid, adjusted to the measured mass, into the food products.

2. The method of claim 1, wherein the step of radiometrically measuring includes the steps of:
passing gamma radiation through the food products, and
measuring the absorption of the gamma radiation.

3. The method of claim 1, wherein the step of radiometrically measuring includes the step of conveying the food products by a conveyor through a radiometric measuring stage, and in the measuring stage, through a radiation curtain of radioactive radiation that extends transverse to the direction of conveyance.

4. The method of claim 1, wherein the step of radiometrically measuring includes the steps of:
a first radiometric mass measurement step performed prior to the injection of the liquid,
a second radiometric mass measurement step performed after the injection, and
a determination step which determines the amount of injected liquid by comparing measured results of the first and second radiometric mass measurement steps.

5. The method of claim 4, wherein the step of radiometrically measuring includes the steps of:
determining the mass of the supplied food products by one of the radiometric mass measurement steps, and
calculating a relative mass increment relative to the amount of product on the basis of this determined mass.

6. The method of claim 5, wherein the step of injecting the liquid into the food products is automatically controlled such that the relative mass increment is adjusted to a target value.

7. Apparatus for processing food products, comprising:
an injector for injecting a liquid into the food products,
a conveyor for conveying the food products through the injector, and
at least one radiometric measuring stage for radiometrically measuring the mass of the food products at the conveyor.

8. Apparatus according to claim 7, wherein:
the conveyor includes a conveyor member,
the radiometric measuring stage is traversed by the conveyor member,
a radiation source is arranged above the conveyor member and directs a radiation curtain onto the food products and the conveyor member, and
at least one sensor for detecting the radiation that has passed through the food products is arranged below the conveyor member.

9. The apparatus of claim 8, wherein said at least one sensor includes a plurality of sensors distributed over the width of the conveyor member.
